(19) United States
(12) Patent Application Publication
(10) Pub. No.: US 2018/0295851 A1
(43) Pub. Date: Oct. 18, 2018

(54) SOLID CREAMY FOOD FORMULATION BASED ON OLIVE OIL, PROCESS FOR ITS PREPARATION AND USES THEREOF

(71) Applicant: MIDA PIÙ S.r.l., Ponte San Giovanni (IT)

(72) Inventors: Filippo POMPILI FERRARI, Ponte San Giovanni (IT); Eraldo ROSSI, Ponte San Giovanni (IT); Roberto LUNEIA, Ponte San Giovanni (IT); Matteo ROSSI, Ponte San Giovanni (IT); Francesco ASCENZI, Ponte San Giovanni (IT)

(21) Appl. No.: 15/767,588

(22) PCT Filed: Oct. 12, 2016
(86) PCT No.: PCT/IT2016/000236

§ 371 Date: Apr. 11, 2018

(30) Foreign Application Priority Data
Oct. 12, 2015 (IT) 102015000060659

(51) Int. Cl. A23D 7/005; A23D 7/01; A23D 7/02; A23D 9/02; A23L 29/00; A23L 29/10; A23L 29/30; A23L 3/3571

(52) U.S. Cl. CPC A23D 7/0056; A23V 2300/40; A23D 7/02; A23D 9/02; A23L 29/06; A23L 29/10; A23L 29/35; A23L 3/3571; A23V 2002/00; A23V 2200/222; A23V 2250/032; A23V 2250/1842; A23V 2250/2131; A23V 2250/5112; A23V 2300/31; A23V 2300/46; A23D 7/013

(57) ABSTRACT

The present invention concerns a solid creamy alimentary formulation based on olive oil comprising olive oil in an amount comprised between 50 and 90% by weight, fat of vegetable origin between 5 and 50% by weight, water between 0 and 25% by weight, emulsifying agents between 0.2 and 1.2% by weight, vegetable fibers for alimentary use between 0.2 and 1.5% by weight, organic acid for alimentary use between 0.01 and 0.15% by weight; a method of manufacturing and uses thereof.

The present invention concerns a solid creamy alimentary formulation based on olive oil, a method of manufacturing and uses thereof.

The invention relates to the field of the food industry in general and more particularly to the field of processing industry of oils and fats of vegetable and even more in particular of olive oil.

In the present specification, when referring to olive oil all its product categories are referred to, both those deriving directly by the simple pressing of olives (lampante (suitably adjusted), virgin and extra virgin), and the one that has undergone correction or extraction processes, such as olive oil, rectified olive oil and olive pomace oil.

It is known that, in recent years, there have been many developments in the food sector, with particular reference to the attention given by the institutions, both national and international, and particularly by the European institutions, by the distribution organizations up to the consumer, to food safety understood as a guarantee of use of foods which are healthy and not harmful, referring also to the nutritional characteristics and the chemical composition of the same. These concepts are pushing beyond the reference regulatory frameworks and food production also takes care of the indications given by the relevant EU bodies, such as the European Food Safety Authority (EFSA), to which it is entrusted the evaluation of the safety of food, to the eating habits and dietary habits of the populations of the different countries of the European Union, divided according to food requirements, geographical location and age group.

In the last decade, special attention was given to fats, used in large scale in food, which have become an integral part of the diet of the populations of European countries and, more generally, of all the developed countries, especially in the form of industrially manufactured consumer products, practical for use at different times of the day: from breakfast, to a snack during the day or during meals.

In this category are positioned countless food products, particularly bakery products, which collect a wide range of types of food products, between which:
biscuits for the breakfast, biscuits and cookies in general, hedonistic, simple, stuffed, healthful, etc.,
substitutes for bread, such as: crisp toasts, bread sticks, sliced bread, etc.,
snacks of various types, croissants, sponge cake, cast, soared, etc.

These types of foods are characterised mainly by manufacturing technology but share many raw materials, just as fats.

Among the latter, the palm or palm kernel oil, is the one most used in food in the world, because, beyond all the negative considerations related to the nutritional value, it is considered one of the best performing oils from the technological point of view, as to be considered indispensable for the manufacturing of some products.

Among the palm oil strengths it is possible to include: the low cost; the high amount of world production; the neutral taste, which does not interfere with the organoleptic characteristics of food products, especially bakery products; the technological functionality in the use, since the melting point of 28-32° C. (SFI value) gives the oil a high foamability (fat ability to entrain air), to become a whipped fat with creamy consistency. The latter physical property, which is obtained with a specific industrial process, before introducing the fat in the dough, gives the product positive organoleptic characteristics, which make the products made by making use also of palm oil, pleasing during mastication, improving the phenomena that occur during chewing which are defined as palatability.

However, the palm oil also has some weak points, first of all the fact of being considered harmful to humans, due to the high saturated fat content and of the fact that, being contained in many foods, the dose which is taken daily is too high compared to that nutritionally adequate for foods rich in saturated fats.

In addition, the intensive use of palm oil has a negative impact on the ecosystem, due to its intensive cultivation, using the turf of forests, which are subsequently destroyed.

These aspects have a negative ethical impact, that more and more limits the propensity of consumers in relation to food products that are made using palm oil. The fluctuating commercial value of such oil must also be considered, due to diversified market demands (the palm oil is also used as a fuel, in particular in the countries of South America).

In recent years, moreover, the refined palm fat (and consequently also the margarines that contain it) was further placed at the center of attention of the consumer and institutions, and is not judged positively, due to the high content of saturated fat (approximately 50% for the oil obtained from the fruit, known as “palm oil” and about 80% for the oil obtained from the seed, called “palm kernel oil”), considered a risk factor for all cardiovascular pathologies. To highlight even more the harmfulness of this fat, it is sufficient to remember that it is the only vegetated fat that contains cholesterol, typical sterol found in animal fat.

Up to now, also, the various attempts made to use the olive oil on bakery products, taking the place of palm oil, have not given positive results because, as is the case for all oils that at room temperature are in the liquid state, during the plastification phase fails to incorporate air, necessary condition to be able to become a cream; causing as a result a precarious incorporation of oil in the dough (whether naturally leavened dough, or cast paste, shortbread etc.) then making the resulting product unpleasant, with greasy consistency and excessive friability.

In this context it is included the solution of the present invention, according to which it is proposed olive oil as a valid alternative to palm oil, since the invention consists in transforming the olive oil in a concrete (solid) fat technologically equivalent to the concrete palm fat.

The solution according to the present invention allows to obtain a product technologically conformed to the requirements of industrial applications, which at the same time ensures positive nutritional characteristics that have been scientifically recognized to olive oil since a long time.

These and other results are obtained according to the present invention by proposing a solid creamy alimentary formulation based on olive oil or extra virgin olive oil as a primary component, which is mixed with a noble vegetable fat (cocoa butter), water and other vegetable products with characteristics of emulsifiers and preservatives.

Purpose of the present invention is therefore to provide a solid creamy alimentary formulation based on olive oil, a method of manufacturing and uses thereof, which allow to overcome the limits of the solutions according to the prior art and to obtain the previously described technical results.

A further object of the invention is that said solid creamy alimentary formulation based on olive oil, said method of manufacturing and said uses thereof can be realized with substantially limited costs, as far as both production costs and management costs are concerned.

Not last object of the invention is to propose a solid creamy alimentary formulation based on olive oil, a method of manufacturing and uses thereof that are simple, safe and reliable.

It is therefore a first specific object of the present invention a solid creamy alimentary formulation based on olive oil as defined in claim 1.

It is additionally a second specific object of the invention a method for the manufacturing of said solid creamy alimentary formulation based on olive oil, as defined in claim 9.

Further preferred aspects of the solid creamy alimentary formulation and of the method for its manufacturing are defined in the respective dependent claims.

It is evident the effectiveness of the solid creamy alimentary formulation based on olive oil, of the method for manufacturing and uses thereof according to the present invention, which leads to the conclusion that the olive oil may be the main raw material that can used in baked products without departing from the performance obtained with the palm oil.

The result sought according to the present invention is therefore to produce a vegetable fat mainly based on olive oil on a large scale to be able to allocate it to:
industries in the food sector, for use on baked goods (both fine and from bakery), creams, pastry products even in place of butter;
pastry and bakery laboratories;
directly to consumers, to be used as a substitute for margarine or as a flavoring in homemade culinary art, with the ability to get the best results that the olive oil used as it can not give.

The invention will be described below for illustrative, but not limitative, purposes, with particular reference to some illustrative examples.

In order to test and manufacture the solid creamy alimentary formulation based on olive oil according to the present invention, a pilot plant was built with a production capacity of 100 kg/h, which allowed the development of the formulation and the manufacture of a quantity necessary to technological experimentation on baked goods and creams.

The technology that was used as a starting point was the one that allows to obtain mixtures of oils and emulsified fats (margarines).

Particular attention was given to the temperatures of plasticization and mechanical refining, in fact, this last step is able to bring the particles possibly present in the solid creamy alimentary formulation based on olive oil according to the present invention to be perfectly incorporated in a stable manner in the emulsion that is obtained. This process allows to make stably solid the fat particles and simultaneously to reduce their dimensions determining the formation of amorphous solid forms of very small dimensions.

Another very important step is that of cooling, which is able to bring the solid creamy alimentary formulation based on olive oil according to the present invention to a final consolidation step of the fat phase and crystallization of the aqueous phase.

The solid creamy alimentary formulation based on olive oil according to the present invention has been made in many recipes, with a variable ratio between olive oil and cocoa butter; the variability of the recipes has also affected the vegetable fiber, the lecithin and the content of water.

For application on bakery products and doughs, the formulation that gave the best results is the following: olive oil in an amount comprised between 50 and 90% by weight, fat of vegetable origin (cocoa butter) between 5 and 50% by weight, water between 0 and 25% by weight, emulsifying agent, in particular lecithin (fluid sunflower lecithin, soybean lecithin, corn lecithin) between 0.2 and 1.2% by weight, vegetable fibers for alimentary use (type α, β or γcyclodextrins) between 0.2 and 1.5% by weight, organic acid for alimentary use (Citric acid, lactic acid) between 0.01 and 0.15% by weight. Furthermore, to improve the microbiological shelf life, to the formulation can be added salt between 0.1 and 1.2% by weight.

More particularly, the optimal formulation, expressed as a percentage composition by weight, is as follows: 70.6% olive oil, 16.3% cocoa butter, 12% water, 0.5% fluid sunflower lecithin, 0.5% cyclodextrin type α, 0.10% citric acid.

By use of the solid creamy alimentary formulation based on olive oil according to the present invention bakery products were obtained that showed organoleptic characteristics and shelf-life comparable to those of products made with palm oil or with margarines of other origin, as will be described in the following with reference to some embodiment, described by way of example and non-limitative.

In particular, the solid creamy alimentary formulation based on olive oil according to the present invention has proved to be validly applicable in the food industry for use in bakery products (both fine and of bread-making), but also in creams and in pastry products.

Table 1 shows a summary diagram of the possible applications of the solid creamy alimentary formulation based on olive oil according to the present invention, in comparison with the results obtained for the same applications, using palm oil.

TABLE 1

| | | Technology with | |
|---|---|---|---|
| | Technology with | the formulation of | |
| Destination | palm oil | the invention | Results |
| Bakery | Plastification of | The same | Incapsulation of |
| confectionery | the fats before | application of | fats in the dough, |
| products, both | use in the dought | palm oil was | almost 20% less |
| dry and with | with | tested with | fat substance to |
| intermiadiate | encapsulation of | excellent results | be used in the |
| humididty | air to modifie the | | final product, |
| | physical state | | better structure, |
| | | | with more |
| | | | uniform |
| | | | organoleptic |
| | | | features and |
| | | | more adequate |
| | | | texture |
| Bakery | Use of fat as | The formulation | Encapsulation of |
| products | such in the | is able to support | fat in the dough, |
| baked with | mixtures with | the same applied | more linked pulp, |
| sourdough, | incorporation of | technology. From | better structure of |
| pizzas, | the same through | tests carried out it | the finished |
| | the mechanical | is assumed that | product with |
| | action of a | the use of the | more uniform |
| | kneading | formulation may | organoleptic |
| | machine, | reduce by 20% | characteristics |
| | lubrication of the | the amount of | and more |
| | gluten network in | added fat with | adequate |
| | order to obtain a | respec to palm oil | textures |
| | “linked” dough | | |
| | that can | | |
| | withstand the | | |
| | leavening | | |
| Creams, sweet | Use of vegetable | With the | Very soft and |
| and salty | oils that need a | formulation it is | velvety cream, |
| (creams with | high mechanical | possible to get | tasty on the |
| cocoa, | strength and | better results with | palate. These |
| chocolate, | protein provided | lower mechanical | products can be |
| etc.), sauces of | by eggs, milk or | strength, it is | intended for both |
| all kinds, | used as well | possible to | people allergic to |
| spreadable | | produce creams | milk and egg |
| sauces | | also without the | protein and |
| | | use or supply of | vegan consumers |
| | | protein | |
| Culinary art, | Spreadabe | Spreadabe | Ease of |
| both | creams derived | cream as it is on | dissolution of the |
| homemade and | from “poor” | all types of bread | cream, very |
| professional | vegetable oils or | and croutons, | persistent taste |
| | butter or | ease of use | with full taste and |
| | margarines | | intense flavor |

The percentages of the individual components may vary according to particular requirements or situations and that is why a range of composition has been indicated, with a minimum threshold and a maximum threshold. The technological characteristics required to fats that are used for the production of bakery products in general, with respect to those necessary for the realization of particular products, such as croissants, are very different and therefore require appropriate changes, always comprised within the composition ranges stated above.

In particular, the composition of the solid creamy alimentary formulation based on olive oil according to the present invention for use in the production of bakery products with intermediate moisture (sweet sourdough) is the following: olive oil in an amount comprised between 78 and 79% by weight, fat of vegetable origin (cocoa butter) between 14 and 16% by weight, water between 3 and 5% by weight, emulsifying agent, in particular lecithin (fluid sunflower lecithin, lecithin of soybean, corn lecithin) between 0.8 and 1.1% by weight, vegetable fibers for alimentary use (cyclodextrins type α, β or γ) 0.4% by weight, organic acid for alimentary use (citric acid, lactic acid) between 0.09 and 0.11% by weight. In addition, to improve the microbiological shelf life, the formulation is added with salt between 0.8 and 1.2% by weight.

This formulation allows to preserve the product, even in the absence of preservatives, even in environments with controlled temperatures higher than the temperature of 4° C., at temperatures of 10-16° C. facilitating the storage with the lowest cost of the same.

As regards the storage of the composition of the solid creamy alimentary formulation based on olive oil according to the present invention before use on finished products, the shelf-life tests have shown that the same has a Time of Minimum Conservation of at least 6 months.

As for the performance on the production technology and the shelf-life of oven products derived therefrom, the product was tested on bakery products with intermediate moisture (sweet sourdough) with very positive feedback both on the technology of kneading, leavening and cooking. The resulting products have received very positive feedback for the organoleptic characteristics and for the shelf life of the finished products equal or even superior to products made with traditional margarines.

Furthermore, the composition of the solid creamy alimentary formulation based on olive oil according to the present invention for use in the production of anhydrous alimentary creams is the following: olive oil in an amount comprised between 78 and 81% by weight, fat of vegetable origin (cocoa butter) between 17 and 19% by weight, water between 0.2 and 1% by weight, emulsifying agent, in particular lecithin (fluid sunflower lecithin, soy lecithin, corn lecithin) between 1.0 and 1.2% by weight, vegetable fibers for alimentary use (cyclodextrins type α, β or γ) between 0.9 and 1.2% by weight, organic acid for alimentary use (citric acid, lactic acid) between 0.01 and 0.05% by weight, salt between 0.1 and 0.2% by weight.

Even in this case, the formulation allows to preserve the product, even in the absence of preservatives, even in environments with controlled temperature not exceeding 20° C. (conditioned and non-refrigerated environments), facilitating the storage with lower costs. In this respect, salt was also added to improve the microbiological shelf life. The shelf-life testing attests a Conservation Minimum Time of at least 6 months.

This particular embodiment of the solid creamy alimentary formulation based on olive oil according to the present invention has been specially designed for the production of anhydrous creams or all those productions involving the use of a fat having a very limited content of water.

Also in this case the results were optimum, both from the application point of view and from the technological point of view of shelf-life of the resulting products. The food creams made with the solid creamy alimentary formulation based on olive oil according to the present invention, in its anhydrous form, are soft texture, very delicate on the palate, extremely spreadable.

Particular attention should be given to the results obtained for the surface treatment of the packaging material of certain products classified as bulk snacks included in bags.

Finally, the preferred composition of the solid creamy alimentary formulation based on olive oil according to the present invention for use in the production of bakery products, sweet and salty, gastronomy and baked to bread, is the following: olive oil in an amount comprised between 63 and 66% by weight, fat of vegetable origin (cocoa butter) between 18 and 21% by weight, water between 13 and 14% by weight, emulsifying agent, in particular lecithin (fluid sunflower lecithin, soy lecithin, corn lecithin) between 0.8 and 1.1% by weight, vegetable fibers for alimentary use (cyclodextrins of type α, β or γ) between 0.4 and 0.6% by weight, organic acid for alimentary use (citric acid, lactic acid) between 0.09 and 0.11% by weight, salt between 0.9 and 1.1% by weight.

According to this preferred embodiment, the formulation was refined to obtain a product which, although in the absence of preservatives, kept in controlled climatic conditions (temperatures from 2 to 4° C.), maintains its physical and chemical characteristics. In this respect salt was also added to improve the microbiological shelf life.

As regards the preservation of solid creamy alimentary formulation based on olive oil according to the present invention prior to be used on finished products, the shelf-life testing states a Conservation Minimum Time of at least 6 months.

The composition of the product according to this preferred embodiment of solid creamy alimentary formulation based on olive oil according to the present invention is designed to obtain the best technical performance for inclusion in the dough in the sweet and salty bakery products, in gastronomy and bread production.

Very positive results were also registered in the culinary application, the solid creamy alimentary formulation based on olive oil according to the present invention has been used for the preparation of filings of fresh pasta products, for the whipping of rice, for the preparation of sauces and pestos.

Even in this case, the stability of the products prepared with the solid creamy alimentary formulation based on olive oil according to the present invention is assured, the shelf-life respect the storage times which are normally given to similar products prepared with fats or margarines of different composition.

To obtain the technological results adaptable to the use for bakery products as described above, the fat used should be at solid state at room temperature, must therefore be foamable, ie have the ability to entrain air when subjected to mechanical force, in such a way to have the ability to be incorporated by the dough in the process of kneading.

However, the olive oil, at room temperature, does not have these features, but is liquid and also the possible formation of air bubbles, which can occur as a result of mechanical stirring together with water, is minimal and not long lasting, thus causing a subsequent rapid separation of the phases.

Therefore the solution proposed according to the present invention has allowed the modification of the physical state of the olive oil, allowing the obtaining of a high-performance concrete fat that, due to the dosage of the other components, has the following characteristics: solidity at room temperature, foamability, ductility in the production of baked goods; keeping practically unchanged the nutritional characteristics of olive oil even in the finished product and thus making it possible for consumers to have the best quality products.

In order to obtain this result, in addition to the specific components of the formulation, the manufacturing method required to obtain the formulation plays a significant importance.

Such a method comprises a plurality of steps, of which in the present description will be mentioned those which contribute in a decisive way to the manufacturing of the solid creamy alimentary formulation based on olive oil according to the present invention. In the industrial field, to such phases determinants are added a plurality of operating steps in the context of the establishment of production, such as by way of not limitative example a step of arrival management of the various raw materials and a step of storage of the same raw materials, as well as a step of packaging and a step of storage of the final product. These steps are obvious for a person skilled in the art and, consequently, will not be illustrated in detail in the following description.

With reference to the decisive steps for the production of solid creamy alimentary formulation based on olive oil according to the present invention, the first referred is the selection of raw materials. The choice of raw materials has to be done, both in qualitative and quantitative terms, with the aim of obtaining an olive oil as a cream with the characteristics described below in the present description, also usable on gluten-free products. Consequently, the raw materials are all completely gluten-free (or with a low content, never exceeding 100 mg/kg). For this aspect, particular importance should be given to the choice of the emulsifying agent, in particular to the choice of lecithin, taking account of its type and its physical state at room temperature and the temperature of the steps of the production process, as well as the choice of the vegetable fiber to be used.

The critical aspect in the choice of raw materials is being able to get the right balance in the composition of the solid creamy alimentary formulation based on olive oil according to the present invention, through the ingredients with emulsifying properties, which must guarantee a level of emulsion that can remain stable during the manufacturing process and provide the right consistency of foaming to the finished product. In this area, the vegetable fiber and the lecithin bind the fat and the water that is contained in the product under certain environmental conditions and in certain ratios. The method of adding and mixing is also very important, both in terms of sequence and in terms of addition conditions (in particular, the mixing temperature), as will be described below.

In particular, the fat components of the solid creamy formulation based on olive oil according to the present invention must be suitably prepared. More particularly, the cocoa butter, before mixing with olive oil, must be melted in a melter, while the olive oil can be added directly into the mixer, without any particular preliminary preparations. In this respect, it is important to establish the proper choice of temperatures and execution times, as will be described below.

Separately, the dissolution of the vegetable fiber and the lecithin is accomplished. In this step, the dissolution must be complete, therefore particular importance is acknowledged to the dissolution temperature, speed of rotation of the dissolver blades and time. These parameters, according to the invention, may vary in the following ranges: the temperature between 25 and 30° C., the speed of the dissolver blades between 40 and 60 Hz, the dissolution time between 10 and 15 min. In this step it is important to find the right combination between the different parameters, to obtain a perfect dissolution, in particular by acting on the relationship between water and vegetable fiber and/or lecithin, so that the vegetable fiber may remain dissolved, avoiding that an excessive dosage can cause its precipitation.

In the next step it is realized the emulsion of all the components of the formulation, previously treated, through the mechanical force of a turbine which also ensures a rotary movement and mixing of the mass and through an in line single-stage emulsifier that picks up the mixture from the bottom of a tank and returns it at the top. This operation, in addition to making the mixing more homogeneous, also favors the emulsion of the aqueous phase with the fat, thanks to the intervention of emulsifying elements already incorporated in water. The operational parameters of this step are the temperature, comprised between 26 and 32° C., the speed of the turbine, between 50 and 70 Hz, the speed of the in line one stage emulsion pump, between 50 and 70 Hz, the time, between 15 and 20 min.

The critical aspect in this procedure is the lowering of the temperature of obtained emulsion from an ideal temperature of emulsion, comprised between 26 and 32° C. to a final temperature comprised between 22 and 24° C., which will allow to subsequently have a suitable step of foaming.

The last step for the manufacturing of the solid creamy alimentary formulation based on olive oil according to the present invention is the stage of foaming, during which the fat emulsion obtained in the previous step, via a strong mechanical action exerted by a rotor with specially shaped blades, that scrape the cylindrical surface of the machine, and a suitable advancement of the mass inside the machine itself, undergoes a foaming and crystallization process, due both to the exerted mechanical force and to the lowering of the temperature.

The foaming and crystallization determine the consistency of the finished product, it is however particularly difficult to find a proper relationship between the machine's cooling temperature, speed of advance of the mass and rotation speed of the rotor. This step is probably the most critical of the whole method, because the balance that must be created is sensitive to even small variations that impact significantly on the characteristics of the fat obtained. The reference parameter for this step of the method are as follows: inlet temperature of the emulsion comprised between 22 and 24° C., output temperature of the foamed product comprised between 18 and 20° C., flow velocity comprised between 30 and 60 Hz, the rotor speed comprised between 40 and 70 Hz.

The product that is obtained at the end of the step of foaming has a creamy texture, soft to the touch, typical of a foamed fat.

The solid creamy alimentary formulation based on olive oil according to the present invention obtained after foaming is packaged in buckets of suitable plastic material or in bags contained in a cardboard box, is subsequently stored at a controlled temperature of 2-4° C., taking its final consistency.

The product thus made can be used as such in the already said preparations shown schematically in Table 1, or it can be subjected to a subsequent step of foaming in mixers for use on baked goods.

All the raw materials that have been tried in the course of the tests carried out for the realization of the invention have undergone a process of optimization through an experimental design which allowed to find the best possible conditions with the lowest number of experimental tests. This procedure made it possible to experience all previously said ranges of the composition of the solid creamy alimentary formulation based on olive oil according to the present invention. The following are the tests that were performed for the optimization of each of the six types of ingredients used for the production of solid creamy alimentary formulation based on olive oil according to the present invention.

### EXAMPLE 1. OPTIMIZING THE AMOUNT OF OLIVE OIL

Being olive oil the main component of the solid creamy alimentary formulation based on olive oil according to the present invention, it has been subject to extensive testing. For quantities of olive oil next to the lower limit of the range described and claimed according to the present invention, the resulting product still has excellent technical characteristics, conferred by the higher amount of cocoa butter present in the composition, necessary to obtain a stable solid fat at room temperature. However, the cost of the formulation thus obtained is negatively affected by the increased presence of cocoa butter, a raw material more expensive than olive oil. Consequently, at equal technological performance, the experimentation was aimed at elevating as much as possible the percentage amount of olive oil in the formulation, since the final objective was also to obtain a solid fat at room temperature to a price as close as possible to the other fats, while maintaining the superior nutritional characteristics compared to all solid fats of vegetable origin according to the prior art. It follows that the best results, judged at equal technological performance, both for the fat in the dough and for the fat in the puff pastry, had percentage quantity of olive oil greater than 80% by weight.

However it is clear that the present invention covers the entire composition range comprised between 50 and 90% by weight of olive oil, since it has been verified that, for some special dietary uses, also products made with compositions at both the lower and the upper thresholds of the identified range (50-90%) have provided interesting results.

### EXAMPLE 2. ALTERNATIVE PRODUCTION OF OLIVE OIL FROM LAMPANTE OLIVE OIL

As said in the introduction to this description, by olive oil reference is made to all types of oils coming directly from olives by simply pressing (lampante, virgin and extra virgin), both the one that has undergone the correction or extraction process, such as olive oil, corrected oil olive and pomace olive oil. In particular, also property said olive oil has been used in this process (obtained by mixing oils adjusted with varying amounts of virgin and extra virgin olive oils), and corrected oil obtained with normal correction processes. Moreover, it was also developed an innovative process of correction of lampante oil, which is not edible as such and could not be used directly. The correction process of lampante oil is carried out directly in the reactor where the oil is placed for obtaining the solid creamy alimentary formulation based on olive oil according to the present invention, and is preliminary to all subsequent steps of the method.

In particular, said correction process includes the following steps:
lampante olive oil is added with a 1:1000 ratio of a lipase immobilized on inert support of fungal or microbial origin, (different types of lipase have been tried which have proved all suitable for the purpose, changing only the efficiency of catalysis they carried out);
closing the reactor and producing a degree of vacuum such as to maintain a residual pressure of 0.2 bar, at a temperature of 60° C. for 2 hours while mixing.

In these conditions esterification of the glycerides naturally present in the oil takes place, due to free fatty acids also present in proportional amounts, catalyzed by the lipases that have been added, thus allowing to obtain as a result a rectified oil with the following characteristics: best of the fat solidification capacity realized with it and consequent increase of the melting point; reduction of the rancidity process; modification of the solid/liquid balance of the triglycerides contained in the oil, which favors the emulsion step and the final structure.

At the end of the correction step, the enzymes are recovered through a suitable filter with narrow mesh and, after being washed with refined oil, they can be used again for a next cycle.

The obtained oil, instead, can be used as normal corrected oil in the production of the solid creamy alimentary formulation based on olive oil according to the present invention by following the previously described procedure.

### EXAMPLE 3. OPTIMIZING THE AMOUNT OF VEGETABLE FAT RICH IN SATURATED FAT (COCOA BUTTER)

To check which saturated vegetable fat was the best for an optimal result, a series of tests have been carried out with cocoa butter, coconut oil, rapeseed oil, corn oil, sunflower oil, cotton seed oil, oil of grape seeds, oil of soybean, sesame oil. Even in this case, the test design was aimed to verify what was the optimal percentage amount of each of the tested oils, to allow the obtained fat to be solid at room temperature.

This test design was always performed taking fixed three fundamental points: namely the fat obtained had to be solid at room temperature, but also have the nutritional characteristics as close as possible to those of the olive oil and have the lowest possible cost of raw materials, as a compromise resulting from the first two fundamental characteristics that could not be departed from.

The result of tests carried out with this test design was defined as the best fat obtained by mixing olive oil with cocoa butter, and also the variables percentage amount of cocoa butter that have been tried have resulted in products that were technologically more suited to specific technological applications, fat dough, fat pastry and fat spreads. many of the tests made it possible to obtain a solid creamy alimentary formulation that was not satisfactory neither for nutritional features or for technological features, even if they presented cost lower than that considered optimal.

### EXAMPLE 4. OPTIMIZING OF THE AMOUNT OF WATER

For the tests simple drinking water was used, which was mixed in variable percentage amount, always with the primary objective to obtain a solid creamy alimentary formulation and to improve the technological characteristics of the same to make it more suitable for technological uses.

### EXAMPLE 5. OPTIMIZE THE AMOUNT OF LECITHIN

To choose the type of lecithin and optimize its amount tests were done with all the lecithins currently available in the market, ie lecithin from soy, sunflower, corn, peanut, oats and wheat. With each of these lecithins it was possible to obtain a solid creamy alimentary formulation with the required features, however that obtained from oats and from wheat were considered inconvenient, as they could contain traces of gluten and therefore be suitable for coeliacs only by properly selecting the product in order to use only that with a gluten content of less than 100 mg/kg, characteristic that all the lecithin present in the wheat market possess, but that must be checked each time before each use. Soy and sweet corn have been used, but not deemed optimal for the potential content of GMO, while peanut was used, but not considered optimal for the costs and for the potential risk of allergens. It was then selected the oil of sunflower in the fluid state, because it was deemed the most performant with regard to the three fundamental characteristics that the solid creamy alimentary formulation object of the invention had to possess.

### EXAMPLE 6. OPTIMIZING THE AMOUNT OF VEGETABLE FIBERS AND CYCLODEXTRINS

For the optimization of the amount of vegetable fibers and cyclodextrins all of the vegetable fibers of foodstuffs on the market have been tried, from the soluble ones such as inulin, pectin, guar gum, mucilage, galactomannans; to the insoluble ones such as maltodextrins, cyclodextrins (α, β and γ), cellulose, hemicellulose, chitin, as well as chitosans, xanthan gum, glucomannan, lignin, cutin. With all these types of fibers solid food formulations were obtained starting from olive oil, however, for the ease of obtaining products that are technologically suitable for use, cyclodextrins (α, β and γ) have been chosen as optimal. Many of the fibers were tested, but not considered optimal, while allowing excellent results, because they come from plants potentially containing gluten or GMOs. So their use is foreseen after verification of compliance with the limits that may allow the gluten-free or GMO free indication in the finished product. In particular, between the various types of cyclodextrins, those a were those that gave the best results, as they probably have the best “host/guest” relationship, which allows them a better distribution at the oil/water interface, thus succeeding to perform their function in an optimal way, even at concentrations lower than the other cyclodextrins.

### EXAMPLE 7. OPTIMIZING THE AMOUNT OF ORGANIC ACID

The addition of an organic acid in the formulation has the function of reducing the pH to make the solid creamy alimentary formulation based on olive oil according to the present invention more stable against microbial deterioration. Many organic acids for use in foodstuffs have been tested (lactic, malic, tartaric, etc.) and all have proved to be suitable for use, however, for the low cost and low organoleptic impact, for the preferred formulation the citric acid was chosen.

### EXAMPLE 8. EXAMPLE OF EXECUTION OF THE INVENTION. TEST OF MANUFACTURING OF A FAT CASTE

5.8 kg of cocoa butter (19.3% by weight with respect to the final formulation obtained), were dissolved at 60° C. in a melter and then were added to 19.5 kg of olive oil (65% by weight), inside of an emulsifier.

Separately, in a dissolver, 4.5 kg of water (15%) were added with 100 g of soybean lecithin (0.34%) and 110 g of α-cyclodextrin (0.36%). The three components were maintained under stirring for 3 minutes until complete dissolution of any solid fraction. The solution was then added in a quantitative way to the mixture of completely melted fats. Following, the emulsifier was actuated, for 25 minutes, and subsequently a transfer pump was turned on to transfer to a previously cooled foamer. A solid creamy alimentary formulation was obtained which rapidly solidified after leaving the foamer. (Solidification point 16.5° C.; melting point 24° C.).

### EXAMPLE 9. TEST OF MANUFACTURING OF FAT PASTE

4.9 kg of cocoa butter (16.3% by weight with respect to the final formulation obtained), were dissolved at 60° C. in a melter and then added to 21.8 kg of olive oil (72.6%), inside an emulsifier. Separately, in a dissolver, 150 g of soybean lecithin (0.5%) were added to 3.0 kg of water (10%), 150 g of cyclodextrin A (0.5%) and 36 g of citric acid (0.12%). The three components were maintained under stirring for 3 minutes until complete dissolution of any solid fraction. The solution was then added in a quantitative way to the mixture of completely dissolved fats. Following, the emulsifier was actuated for 25 minutes, after which the transfer pump was actuated to a previously cooled foamer. A creamy solid fat was obtained that solidified quickly after leaving the foamer. (Solidification point 20.5° C.; melting point 25° C.).

### EXAMPLE 10. TEST OF MANUFACTURING OF PUFF PASTRY FAT PASTE

5.9 kg of cocoa butter (19.6% by weight with respect to the final weight of the formulation obtained), were dissolved at 60° C. in a melter and then added to 19.3 kg of extra virgin olive oil (64.2%), inside of an emulsifier. Separately, in a dissolver, 4.5 kg of water (15%) were added with 210 g of soybean lecithin (0.70%) and 150 g of A cyclodextrin (0.50%). The three components were maintained under stirring for 3 minutes until complete dissolution of any solid fraction. The solution was then added in a quantitative way to the mixture of completely dissolved fats. Subsequently the emulsifier was actuated for 25 minutes, after which a transfer pump was turned on to a previously cooled foamer. A creamy solid fat was obtained that solidified quickly after leaving the foamer.

### EXAMPLE 11 TEST OF APPLICATION OF THE FORMULATION FOR THE MANUFACTURE OF LEAVENED BAKERY PRODUCTS (CREAM PUFFS)

The formulation obtained in Example 8 was dissolved in water in a ratio 1:3 and subsequently lead to boiling until complete dissolution. All other ingredients were then added, flour, starch, etc. in the proportions that are normally used in recipes for the realization of this particular bakery product (puffs).

The product, after cooking, has presented perfectly leavened and the inner cavity required for filling occurred uniform and well-defined. The use of the solid creamy alimentary formulation based on olive oil according to the present invention had in no way affected the technological performance of the product and also the organoleptic result was absolutely fine, because the origin of the main ingredient of the formulation was absolutely not perceived.

### EXAMPLE 12. TEST OF APPLICATION FOR THE MANUFACTURING OF BAKERY PRODUCTS (SHORTBREAD)

The formulation obtained in Example 9 was mounted in a planetary mixer for 8 minutes, to obtain a volume mass at least three times higher than that of starting, very white in color and with impalpable creamy consistency. Other ingredients were added to the fat, such as eggs, flour, starch, etc. that are normally used for the realization of shortbread.

The product, after cooking, had excellent coloring, adequate crispness and texture to the bursting test. Also from the organoleptic point of view the result was optimal, in fact, the product had a good aroma and a very intense flavor, with a very pleasant palatability, which made it absolutely palatable. Even in this case, the presence of olive oil as the main component of the fat was not perceived.

### EXAMPLE 13. TEST OF APPLICATION FOR THE MANUFACTURING OF “PUFFED” BAKERY PRODUCTS (PUFF PASTRY AND CROISSANT)

The formulation obtained in Example 10 was incorporated into a double sheet of a normal dough of water, eggs and flour, in typical proportions used for the realization of these bakery products (puff pastry and croissant). Then, the mixture was passed into the rollers of the sheeter for a sufficient number of times to perfectly embrace the fat, as this particular implementation of technology requires.

The product, after cooking, had a good aroma and a good leavening, which determined a perfect external form and a fine and homogeneous internal alveolation. Also the flavor was very good, with an excellent palatability even compared to the traditional product realized in parallel in the same conditions, but using butter in place of the solid creamy alimentary formulation based on olive oil according to the present invention. Even in this case, as in the previous two cases, the product did not present the slightest perfumes or flavors that recalled the origin of the used fat.

The product was then used in various other tests on all bakery products (shortbread, flows pastries, cake pastries, yeast dough, puff pastries, etc.) and provided surprising results in all cases. Some of these products were then subjected to a panel test and to shelf-life tests.

Products made with the solid creamy alimentary formulation based on olive oil according to the present invention have a more persistent flavor and are more friable, without, however, determine the perception of olive oil.

In shelf-life tests the products have undergone the same aging of the products prepared with margarine, not in the least affecting the organoleptic profile.

The present invention has been described for illustrative, but not limitative purposes, according to its preferred embodiments, but it is to be understood that variations and/or modifications can be made by those skilled in the art without departing from the related scope of protection, as defined by the appended claims.

1. Solid creamy alimentary formulation based on olive oil comprising olive oil in an amount comprised between 50 and 90% by weight, fat of vegetable origin between 5 and 50% by weight, water between 0 and 25% by weight, emulsifying agents between 0.2 and 1.2% by weight, vegetable fibers for alimentary use between 0.2 and 1.5% by weight, organic acid for alimentary use between 0.01 and 0.15% by weight.

2. Solid creamy alimentary formulation based on olive oil according to claim 1, characterised in that it additionally comprises salt in an amount comprised between 0.1 and 1.2% by weight.

3. Solid creamy alimentary formulation based on olive oil according to claim 1, characterised in that said fat of vegetable origin is cocoa butter.

4. Solid creamy alimentary formulation based on olive oil according to claim 1, characterised in that said emulsifying agents are made of lecithin.

5. Solid creamy alimentary formulation based on olive oil according to claim 4, characterised in that said lecithin is fluid sunflower lecithin.

6. Solid creamy alimentary formulation based on olive oil according to claim 1, characterised in that said vegetable fibers for alimentary use are made of cyclodextrin.

7. Solid creamy alimentary formulation based on olive oil according to claim 6, characterised in that said cyclodextrin is α-cyclodextrin.

8. Solid creamy alimentary formulation based on olive oil according to claim 1, characterised in that said organic acid is made of citric acid.

9. Solid creamy alimentary formulation based on olive oil according to claim 1, characterised in that it comprises olive oil in an amount comprised between 78 and 79% by weight, fat of vegetable origin between 14 and 16% by weight, water between 3 and 5% by weight, emulsifying agent between 0.8 and 1.1% by weight, vegetable fibers for alimentary use 0.4% by weight, organic acid for alimentary use between 0.09 and 0.11% by weight.

10. Solid creamy alimentary formulation based on olive oil according to claim 9, characterised in that it additionally comprises an amount of salt comprised between 0.8 and 1.2% by weight.

11. Solid creamy alimentary formulation based on olive oil according to claim 1, characterised in that it comprises olive oil in an amount comprised between 78 and 81% by weight, fat of vegetable origin between 17 and 19% by weight, water between 0.2 and 1% by weight, emulsifying agent between 1.0 and 1.2% by weight, vegetable fibers for alimentary use between 0.9 and 1.2% by weight, organic acid for alimentary use between 0.01 and 0.05% by weight.

12. Solid creamy alimentary formulation based on olive oil according to claim 11, characterised in that it additionally comprises an amount of salt comprised between 0.1 and 0.2% by weight.

13. Solid creamy alimentary formulation based on olive oil according to claim 1, characterised in that it comprises olive oil in an amount comprised between 63 and 66% by weight, fat of vegetable origin between 18 and 21% by weight, water between 13 and 14% by weight, emulsifying agent between 0.8 and 1.1% by weight, vegetable fibers for alimentary use between 0.4 and 0.6% by weight, organic acid for alimentary use between 0.09 and 0.11% by weight.

14. Solid creamy alimentary formulation based on olive oil according to claim 13, characterised in that it additionally comprises an amount of salt comprised between 0.9 and 1.1% by weight.

15. Solid creamy alimentary formulation based on olive oil according to claim 1, characterised in that it comprises 70.6% by weight di olive oil, 16.3% by weight di cocoa butter, 12% by weight di water, 0.5% by weight di fluid sunflower lecithin, 0.5% by weight di α-cyclodextrin, 0.10% by weight di citric acid.

16. Method of manufacturing a solid creamy alimentary formulation based on olive oil, as defined in claim 1, comprising the following steps:
melting said saturated vegetable fat,
dissolving said emulsifying agents and said vegetable fibers, preferably by adding water, to obtain a solution of emulsifying agents and vegetable fibers,
mixing said saturated vegetable fat, said solution of emulsifying agents and vegetable fibers and olive oil, to obtain an emulsion,
lowering the temperature of said emulsion down to a range comprised between 22 and 24° C.,
plasticizing and crystallizing said emulsion by means of mechanical action of a rotor, at the same time cooling down to a temperature comprised between 18 and 20° C.

17. Method of manufacturing a solid creamy alimentary formulation based on olive oil according to claim 16, characterised in that, if said olive oil è lampante olive oil, it is provided for a preliminary step of oil correction, comprising the following sub-steps:
adding to the oil a lipase that is immobilized on an inert support of fungal or microbial origin, in a ratio 1:1000;
producing a degree of vacuum such as to maintain a residual pressure of 0.2 bar, at a temperature of 60° C. for 2 hours;
removing the lipase from the oil.
